(19) United States
(12) Patent Application Publication
(10) Pub. No.: US 2006/0072948 A1
(43) Pub. Date: Apr. 6, 2006

(54) Motor drive control apparatus, image forming apparatus, and control method for driving mechanisms

(75) Inventors: Kazunori Miyake, Toride-shi (JP); Hiromichi Tsujino, Moriya-shi (JP); Hidenori Sunada, Toride-shi (JP); Toru Ono, Moriya-shi (JP)

Correspondence Address: ROSSI, KIMMS & McDOWELL LLP., P.O. BOX 826, ASHBURN, VA, 20146-0826, US

(73) Assignee: Canon Kabushiki Kaisha, Ohta-ku (JP)

(21) Appl. No.: 11/242,116

(22) Filed: Sep. 30, 2005

(30) Foreign Application Priority Data
Oct. 1, 2004 (JP) 2004-290563

(51) Int. Cl. G03G 15/00

(52) U.S. Cl. 399/361

(57) ABSTRACT

A motor drive control apparatus which are capable of improving quietness during operation of a motor without the need of modifying the motor driving circuit and without increasing the load torque on the motor. The motor drive control apparatus is connected to a pulse motor via a driving gear disposed on an output side of the motor, and a driven gear engaging the driving gear. The motor drive control apparatus performs drive control in which the motor is driven to transmit a driving force of the motor to a load via the driving gear and the driven gear, and performs position control in which the driving gear is moved by a predetermined amount such that a gap formed between the driving gear and the driven gear is reduced or removed, before the drive control is performed. The drive control is performed when a predetermined period of time has elapsed after the position control is performed.

### BACKGROUND OF THE INVENTION

1. Field of the Invention

The present invention relates to a motor drive control apparatus for controlling a driving mechanism that transmits a driving force from a motor to a load through gears, an image forming apparatus incorporating the motor drive control apparatus, and a control method for the driving mechanism.

2. Description of the Related Art

Various apparatuses employ a driving mechanism configured to transmit a driving force of a motor to a load through a driving gear mounted on a rotary shaft of the motor and a transmission gear engaging the driving gear. Due to manufacturing and assemblage tolerances, such a driving mechanism is subject to a gap or clearance (backlash) between the driving gear and the transmission gear. Consequently, during operation of the motor, noise can be generated by backlash of the gears or the like.

To address this problem, there have been proposed a technique that uses an improved motor driving circuit for noise suppression (e.g. Japanese Laid Open Patent Publication (Kokai) No. 2002-272186) and a technique that uses an improved driving mechanism in which a mechanical member (spring) is added to the transmission gear for example, to eliminate the gap for noise reduction (e.g. Japanese Laid Open Patent Publication (Kokai) No. H08-257208).

However, according to the technique described in Japanese Laid Open Patent Publication (Kokai) No. 2002-272186, which uses the improved driving circuit to suppress noise, the motor driving circuit is complicated, leading to increased cost. A typical example of such a motor driving circuit uses a dedicated integrated circuit (motor driver IC) that is configured by integrating part of a driving circuit and a logic circuit of the motor driving circuit. However, with such an IC, since a circuit section that is to be modified for noise reduction, is integrated in the IC, it is difficult to implement a circuit modification that achieves complete noise suppression.

Japanese Laid-Open Patent Publication (Kokai) No. H08-257208, in which the spring is added to energize or urge the gear to reduce a play between the gears, however, suffers from a problem that load torque on the motor required for driving the load increases and hence output torque required of the motor increases, leading to an increased size of the motor.

### SUMMARY OF THE INVENTION

It is an object of the present invention to provide a motor drive control apparatus, an image forming apparatus incorporating the motor drive control apparatus, and a control method for a driving mechanism, which have overcome the above problems.

It is another object of the present invention to provide a motor drive control apparatus, an image forming apparatus incorporating the motor drive control apparatus, and a control method for a driving mechanism, which are capable of improving quietness during operation of a motor without the need of modifying the motor driving circuit and without increasing the load torque on the motor.

To attain the above objects, in a first aspect of the present invention, there is provided a motor drive control apparatus connected to a motor via a driving mechanism including a driving gear disposed on an output side of the motor, and a driven gear engaging the driving gear, comprising a drive control section that drives the motor to transmit a driving force of the motor to a load via the driving gear and the driven gear, and a position control section that performs position control to move the driving gear by a predetermined amount such that a gap formed between the driving gear and the driven gear is reduced or removed, before the drive control section performs drive control to drive the driving gear and the driven gear, wherein the drive control section performs the drive control when a predetermined period of time has elapsed after the position control is performed by the position control section.

Preferably, the predetermined period of time is set to a period of time required for vibrations of the driving gear or the driven gear caused by execution of the position control to converge.

Preferably, the position control section sets output torque of the motor during execution of the position control to a value less than that of the motor during execution of the drive control.

Also preferably, the position control section sets resolution of a method of excitation of the motor during execution of the position control to a value higher than that of a method of excitation of the motor during execution of the drive control.

Preferably, the drive control section progressively decreases acceleration of the motor during execution of the drive control with time.

To attain the above objects, in a second aspect of the present invention, there is provided a motor drive control apparatus connected to a motor via a driving mechanism including a driving gear disposed on an output side of the motor, and a driven gear engaging the driving gear, comprising a drive control section that drives the motor to transmit a driving force of the motor to a load via the driving gear and the driven gear, a position control section that performs position control to move the driving gear by a predetermined amount such that a gap formed between the driving gear and the driven gear is reduced or removed, before the drive control section performs drive control to drive the driving gear and the driven gear, and a vibration sensor that detects the level of vibrations generated by driving of the driving gear and the driven gear by the motor, wherein the drive control section performs the drive control when the level of vibrations detected by the vibration sensor falls below a predetermined value.

To attain the above objects, in a third aspect of the present invention, there is provided an image forming apparatus comprising an image forming section that forms an image on a recording material, a first roller that feeds the recording material, a first motor that drivingly drives the first roller, a second roller that feeds the recording material fed by the first roller to an image forming position of the image forming portion, a second motor that rotatively drives the second roller, a driving gear disposed on an output side of the second motor, a driven gear engaging the driving gear, a sensor that detects the recording material upstream of the second roller, a drive control section that drives the second motor to transmit a driving force of the second motor to a load via the driving gear and the driven gear, and a position control section that performs position control to move the driving gear by a predetermined amount such that a gap formed between the driving gear and the driven gear is reduced or removed, before the drive control section performs drive control to drive the driving gear and the driven gear, wherein the position control section performs the position control of the second motor when a predetermined period of time has elapsed after detection of the recording material by the sensor.

To attain the above objects, in a fourth aspect of the present invention, there is provided a control method for controlling a driving mechanism that drives a motor to transmit a driving force of the motor to a load via a driving gear disposed on an output side of the motor and a driven gear engaging the driving gear, comprising a position control step of performing position control to move the driving gear by a predetermined amount such that a gap formed between the driving gear and the driven gear is reduced or removed, and a drive control step of performing drive control of the motor to drive the load when a predetermined period of time has elapsed after the position control is performed in the position control step.

To attain the above objects, in a fifth aspect of the present invention, there is provided a control method for controlling a driving mechanism that drives a motor to transmit a driving force of the motor to a load via a driving gear disposed on an output side of the motor and a driven gear engaging the driving gear, comprising a position control step of performing position control to move the driving gear by a predetermined amount such that a gap formed between the driving gear and the driven gear is reduced or removed, a detecting step of detecting a level of vibrations generated by driving of the driving gear and the driven gear by the motor, and a drive control step of performing drive control of the motor to drive the load when the level of vibrations detected in the detecting step falls below a predetermined value after the position control step.

The above and other objects, features, and advantages of the invention will become more apparent from the following detailed description taken in conjunction with the accompanying drawings.

### BRIEF DESCRIPTION OF THE DRAWINGS

FIG. 1 is a block diagram schematically showing the arrangement of a motor drive control apparatus according to an embodiment of the present invention;

FIG. 2 is a graph showing, by way of example, a position control pattern for a pulse motor, and a motor control pattern for the pulse motor;

FIG. 3A is a view showing an example in which a clearance is formed between a driving gear and a transmission gear;

FIG. 3B is a view showing an example in which the clearance between the driving gear and the transmission gear is almost reduced to zero;

FIG. 4 is a graph showing examples of the position control pattern and the motor control pattern for the pulse motor;

FIG. 5A is a diagram showing a noise waveform detected during operation (driving) of the pulse motor using only a motor control pattern (pattern 1);.

FIG. 5B is a diagram showing a noise waveform detected during operation (driving) of the pulse motor using only a motor control pattern (pattern 2) when the pulse motor is driven with a clearance between the gears;

FIG. 5C is a diagram showing a noise waveform detected during operation (driving) of the pulse motor using only the motor control pattern (pattern 2) when the pulse motor is driven with no clearance between the gears;

FIG. 6 is a diagram showing a waveform of vibrations detected by a vibration sensor of the motor drive control apparatus;

FIG. 7 is a flowchart showing a vibration reducing process executed by the motor drive control apparatus;

FIG. 8 is a view schematically showing the internal construction of an image forming apparatus to which the motor drive control apparatus according to the embodiment is applied; and

FIG. 9 is a timing diagram showing an example of control of a registration motor of the image forming apparatus.

FIG. 10 is a flowchart showing another example of vibration reducing process executed by the motor drive control apparatus.

### DETAILED DESCRIPTION OF THE PREFERRED EMBODIMENTS

The present invention will be described with reference to the drawings showing a preferred embodiment thereof.

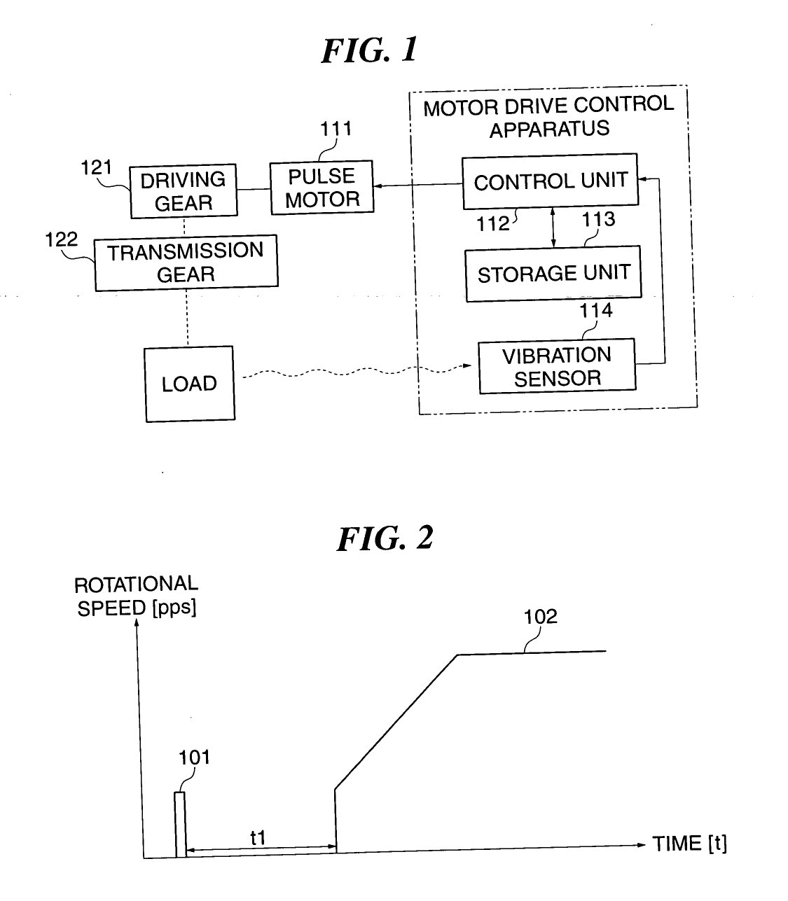

FIG. 1 is a block diagram schematically showing the arrangement of a motor drive control apparatus according to an embodiment of the present invention;

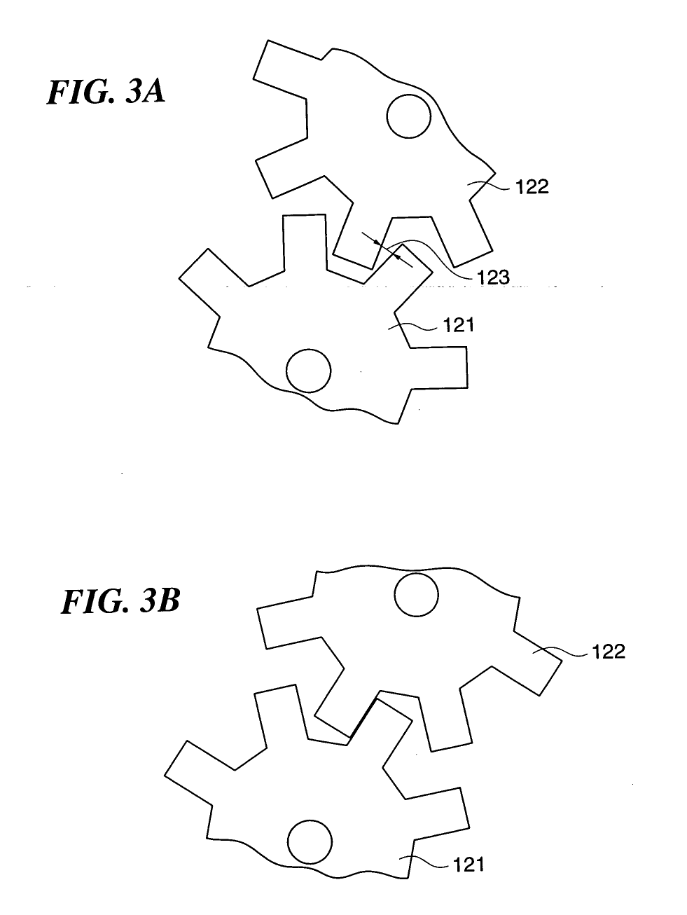

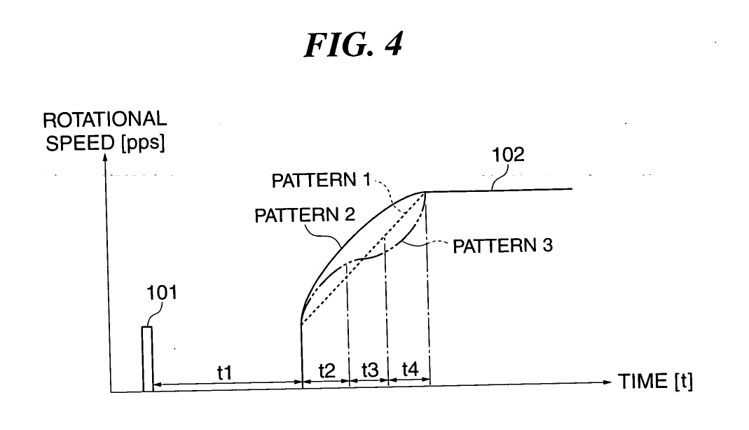

As shown in FIG. 1, the motor drive control apparatus is comprised of a control unit 112, a storage unit 113, and a vibration sensor 114. The control unit 112 supplies a pulse motor (stepper motor) 111 with driving pulses corresponding to desired control pattern data. By thus supplying driving pulses to the pulse motor 111, drive control in which a driving gear 121 and a transmission gear 122 (see FIG. 3) are driven in a normal way and position control in which the driving gear 121 is driven to move by a predetermined amount are performed. The storage unit 113 stores control pattern data which correspond to a position control pattern and a motor control pattern, respectively (see FIG. 4). The vibration sensor 114 detects vibrations due to collision between the driving. gear 121 and the transmission gear 122, and/or generated by a load and outputs a vibration detection signal to the control unit 112.

In the present embodiment, the position control (using the position control pattern) is first carried out to move (rotate) the driving gear 121 by the predetermined amount so that a clearance (gap) between the driving gear 121 and the transmission gear 122 is reduced or minimized nearly to zero, before the drive control (using the motor control pattern) is carried out to drive (rotate) the driving gear 121 and the transmission gear 122 in a normal way. Further, the control unit 112 starts the drive control when a predetermined period of time has elapsed after execution of the position control, and during the drive. control, the control unit 112 progressively reduces the degree of acceleration of the pulse motor 111 with time if the pulse motor 111 is accelerated. Alternatively, even before the lapse of the predetermined period of time after the execution of the position control, when the vibrations detected by the vibration sensor 114 lower to a threshold value or less, the control unit 112 starts the drive control.

Further, the control unit 112 sets the output torque of the pulse motor 111 during execution of the position control such that the output torque of the pulse motor 111 during execution of the position control is less than that of the pulse motor during execution of the drive control. Further, the control unit 112 set resolution of an excitation method used to excite the pulse motor 111 during execution of the position control to a value higher than that of an excitation method used to excite the pulse motor 111 during execution of the drive control. Further, the control unit 112 set the time interval between the execution of the position control and the start of the drive control to the above-mentioned predetermined period of time. The predetermined period of time is selected at such a value that is required for vibrations of the driving gear 121 or the transmission gear 122 caused by operation of the position control to converge.

FIG. 2 is a graph showing, by way of example, the position control pattern and the motor control pattern for the pulse motor 111.

In FIG. 2, the ordinate represents the rotational speed of the pulse motor 111, and the abscissa represents elapsed time. FIG. 2 illustrates two patterns, i.e. the position control pattern 101 and the motor control pattern 102. The position control pattern 101 is set to reduce or eliminate a gap 123 between the driving gear 121 and the transmission gear 122 (see FIG. 3). The motor control pattern 102 is set to drive or operate the driving gear 121 and the transmission gear 122 in a normal way.

FIG. 3A shows an example in which the gap 123 is present between the driving gear 121 and the transmission gear 122. FIG. 3B shows an example in which the gap 123 between the driving gear 121 and the transmission gear 122 is removed.

The driving gear 121 is secured to a rotary shaft of the pulse motor 111, and is driven by the rotating pulse motor 111. The transmission gear 122 mates with the driving gear 121 to transmit the driving force of the motor supplied via the driving gear 121 to the load. The gap 123 is formed between the driving gear 121 and the transmission gear 122. The gap 123 inevitably occurs due to manufacturing and assemblage tolerances of component parts such as the driving gear 121 and the transmission gear 122. It was conventionally very difficult to eliminate the gap to zero.

In the conventional pulse motor control, the pulse motor was driven using only the motor control pattern 102 for driving a gear train, without inputting driving pulses according to the position control pattern 101 to the pulse motor. In this case, as shown in FIG. 3A, the pulse motor is driven with the gap 123 present between the gears, so that in a self-starting region where the pulse motor can start to positively move against a load to be driven, the gears will come into collision.

The pulse motor is accelerated from the self-start region and then is continuously driven without vibrations caused by the collision of the gears being suppressed. Thus, with the conventional pulse motor control, it takes a significant period of time before the vibrations are reduced or converge. Further, there is a possibility that the vibrations caused by the collision of the gears and vibrations generated by the acceleration of the pulse motor resonate to amplify the vibrations.

To address the above problem, in the pulse motor control of the present embodiment, driving pulses according to the position control pattern 101 is input to the pulse motor 111 before driving pulses according to the motor control pattern 102 are input to the pulse motor 111. This causes the gap 123 to be removed so that the driving gear 121 and the transmission gear 122 are brought into a positional relationship as shown in FIG. 3B.

The position control pattern 101 serves to remove the gap 123 between the driving gear 121 and the transmission gear 122. Hence, during position control using the position control pattern, the load torque applied to the pulse motor 111 is lower than that during the driving control of driving the gears in a normal way. Thus, the pulse motor 111 is controlled to produce a relatively low output torque to prevent the pulse motor 111 from generating unnecessary vibrations. Namely, the position control pattern 101 for driving the driving gear 121 and the transmission gear 122 in a normal way is set to have a lower driving current value than that of the motor control pattern 102.

The driving current value of the position control pattern 101 is set such that the motor driven by that current produces an output torque at which the gap 123 can be removed. Preferably, the driving current value of the pattern 101 is set to a minimum value at which the pulse motor can rotate by itself without causing loss of synchronism. Further, by driving the pulse motor with the minimum driving current value, the impact of collision of the gears 121 and 122 can be reduced or minimized. This also serves to prevent the gap 123 from being increased again due to the collision and vibrations.

To reduce the gap 123 to zero with accuracy, when the pulse motor 111 is driven by the two-phase excitation method using the motor control pattern 102, the position control pattern 101 may be designed to drive the pulse motor 111 by the one-two phase (half-step) excitation method or the micro step excitation method. Specifically, the amount of advance per driving pulse of the position control pattern 101 is set to be lower than that of the motor control pattern 102. The use of the excitation method with such a high resolution minimizes the collision between the gears.

Further, after driving pulses according to the position control pattern 101 are applied to the pulse motor 111, a very low current is applied to the pulse motor 111 for a predetermined period of time t1 (see FIG. 2) to hold the pulse motor 111 in an excited state for respective phases thereof so that the driving gear 121 and the transmission gear 122 are held in positions shown in FIG. 3B. In this way, the gear collision and vibrations caused by the gap 123 between the driving gear 121 and the transmission gear 122 are avoided so that noise generated upon the startup of the pulse motor can be suppressed.

FIG. 4 is a graph showing examples of the position control pattern and the motor control pattern for the pulse motor 111.

In FIG. 4, the ordinate represents the rotational speed of the pulse motor 111, and the abscissa indicates elapsed time. FIG. 4 illustrates combinations of the position control pattern 101 and the motor control pattern 102. The position control pattern 102 can be set to any of three patterns i.e. a pattern 1 (broken line), a pattern 2 (solid line), and a pattern 3 (two-dot chain line).

The pattern 1 (broken line) is a startup pattern according to which acceleration of the pulse motor 111 is maintained constant during the startup period of the pulse motor 111.

The pattern 2 (solid line) is a startup pattern according to which the acceleration of the pulse motor 111 during the startup period initially set to a value corresponding to a frequency (self-starting frequency) at which the load to be driven can be fully driven, and then the acceleration is decreased as the time elapses. With the pattern 2, the pulse motor 111 can quickly leave a vibration region thereof present in a low frequency range, whereby the noise generated upon the startup of the pulse motor 111 can be further reduced, compared with the pattern 1.

The pattern 3 (two-dot chain line) is a startup pattern according to which an average acceleration of the pulse motor 111 is set to be higher than that of a conventional linear (constant) acceleration pattern (pattern 1) during a first time interval t2; the average acceleration of the pulse motor 111 is set to be lower than that of the conventional linear acceleration pattern (pattern 1) during a second interval t3; and the average acceleration of the pulse motor 111 is set to be higher than an average acceleration of the pulse motor 111 during the second time interval t3 and the acceleration of the conventional linear acceleration pattern, during a final time interval t4.

With the pattern 3, first, the pulse motor 111 is controlled to quickly exit the vibration region, similarly to the pattern 1 (time interval t2). Then, vibrations that are generated during the time interval t2 are quickly attenuated (time interval t3). Since the acceleration is decreased during the interval t3, the pulse motor reaches a target velocity with delay. To compensate for the delay, the acceleration is increased in a subsequent high frequency range where less vibrations are generated (time period t4).

In this way, the pattern 3 is set such that the acceleration is set to be high for a predetermined period of time after the startup of the pulse motor 11, then the acceleration is decreased for another predetermined period of time, and finally the acceleration is set to be high again and maintained high until a target frequency is reached. Therefore, the period of time required for the pulse motor 111 to be accelerated can be shortened, and vibrations generated during the acceleration of the pulse motor 111 can be reduced to be lower than in the case of the pattern 2.

In the present embodiment, as shown in FIG. 4, the position control according to the position control pattern 101 is carried out before the drive control using the motor control pattern 102 (any of patterns 1 to 3) is carried out. Therefore, the gap 123 formed between the driving gear 121 and the transmission gear 122 can be reduced nearly to zero, and vibrations due to the gear collision upon the startup of the pulse motor can be reduced to the-minimum possible level.

When a pattern with high acceleration of the pulse motor during startup, such as the pattern 2 or 3 in FIG. 4, is used, however, the impact of collision of the gears with the gap 123 therebetween is large, causing generation of large noise. To avoid this, the position control pattern 101 is used to control the pulse motor so as to eliminate the gap 123 between gears before the control using the motor control pattern 102, which is very effective in reducing the noise of the apparatus.

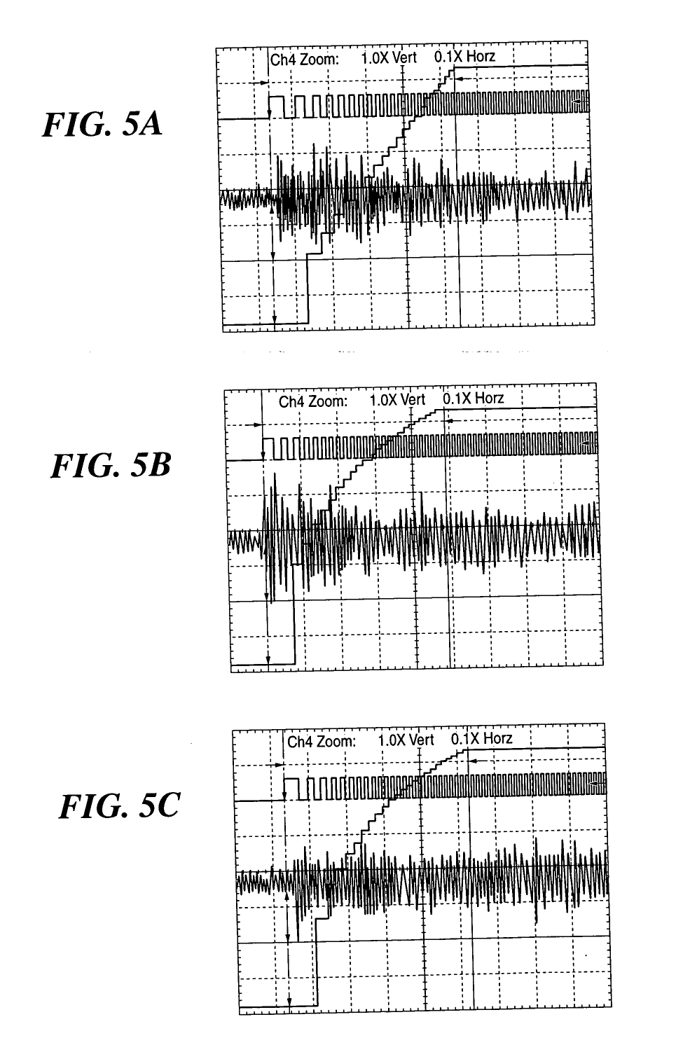

FIG. 5A is a diagram showing a noise waveform detected during operation (driving) of the pulse motor 111 using only the motor control pattern (pattern 1), as well as driving pulses for the pulse motor 111 and acceleration thereof. FIG. 5B is a diagram showing a noise waveform detected during operation (driving) of the pulse motor 111 using only the motor control pattern (pattern 2) when the pulse motor 11l is driven with a clearance or gap between the gears, as well as driving pulses for the pulse motor 111 and acceleration thereof. FIG. 5C is a diagram showing a noise waveform detected during operation (driving) of the pulse motor 111 using only the motor control pattern (pattern 2) when the pulse motor is driven with no gap between the gears, as well as driving pulses for the pulse motor 111 and acceleration thereof.

As shown in FIG. 5A, when the linear pattern 1 is applied to acceleration of the pulse motor 111, it takes long for vibrations to converge and noise is generated over a long period of time since the pulse motor 111 is driven in the vibration region over a long period of time.

Comparison between the condition of FIG. 5B and that of FIG. 5C will show that a larger amount of noise is generated upon the startup of the pulse motor in the case of FIG. 5B than in the case of FIG. 5C. That is, the noise of the pulse motor is reduced to the lowest level in the case of FIG. 5C.

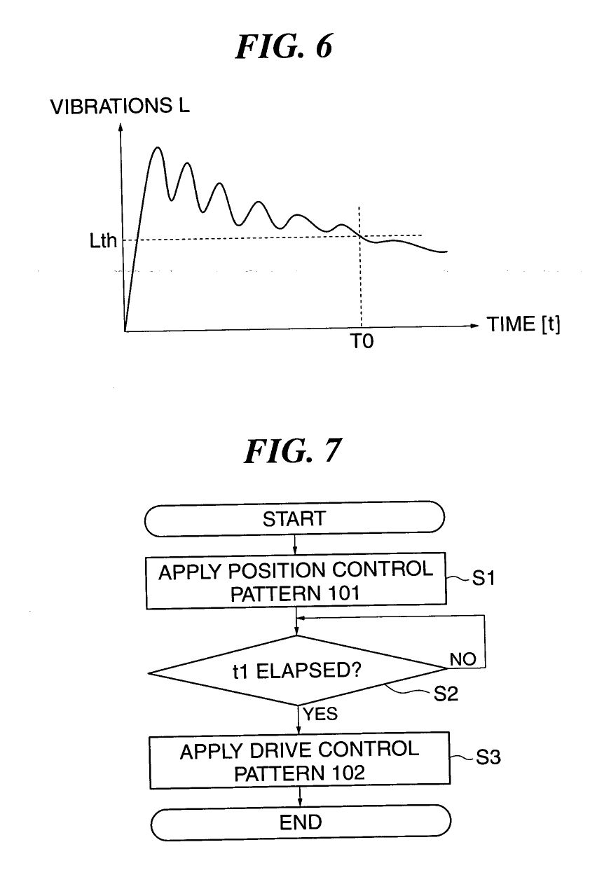

FIG. 6 is a diagram showing a waveform of vibrations detected by the vibration sensor 114 of the motor drive control apparatus.

In FIG. 6, the ordinate represents the level of vibrations, and the abscissa represents elapsed time. The detected waveform has been obtained by the vibration sensor 114 when the pulse motor 111 is driven using the position control pattern 101. In FIG. 6, symbol Lth indicates a vibration threshold value, and symbol T0 indicates a time when vibrations L detected by the vibration sensor 114 converges to the threshold value Lth.

FIG. 7 is a flowchart showing a vibration reducing process executed by the motor drive control apparatus.

Referring to FIG. 7, when the control unit 112 supplies driving pulses according to the position control pattern 101 to the pulse motor 111 (step S1), vibrations are generated in the driving gear 121, the transmission gear 122, and the load, which are driven by the pulse motor 111. Then, the control unit 112 determines whether or not the predetermined period of time t1 has elapsed after the input of the driving pulses according to the position control pattern 101 (step S2). When the control unit 112 determines that the predetermined period of time t1 has elapsed (YES to the step S2), the control unit 112 supplies driving pulses according to the motor control pattern 102 to the pulse motor 111 (step S3).

According to the above control, by first applying driving pulses according to the position control pattern 101 to the pulse motor 111, the gap 123 present between the driving gear 121 and the transmission gear 122 is reduced or removed. Therefore, vibrations caused by the gap 123 upon the startup of the pulse motor 111 can be effectively or reliably reduced or removed before driving pulses according to the motor control pattern 102 are supplied to the pulse motor 111, whereby suppression of noise can be reliably achieved.

Next, a description is given of an image forming apparatus to which the motor drive control apparatus according to the present embodiment is applied.

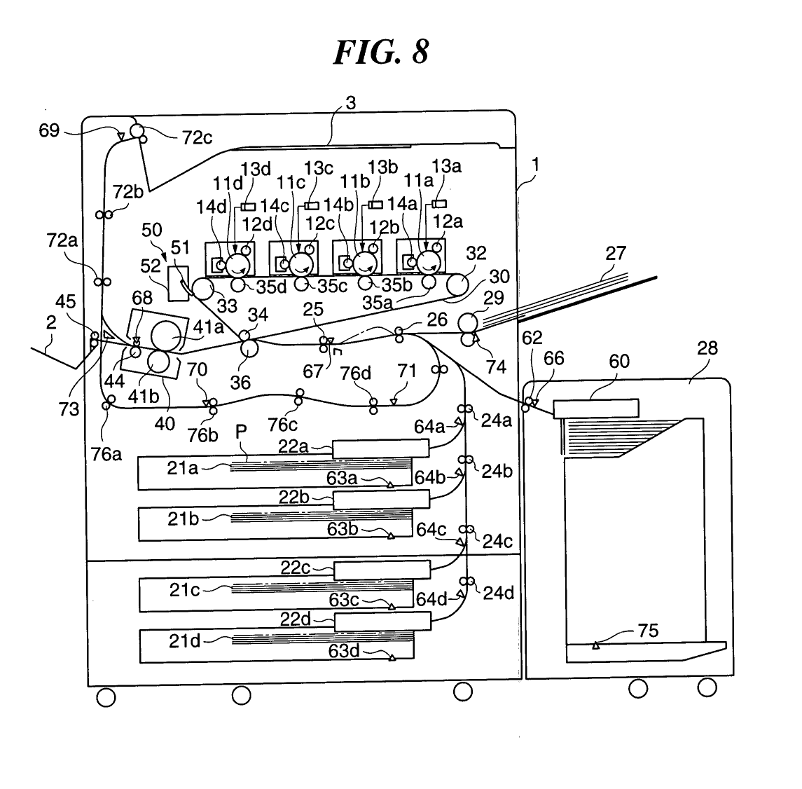

FIG. 8 is a view schematically showing the internal construction of the image forming apparatus to which the motor drive control apparatus of the present embodiment is applied.

As shown in FIG. 8, the image forming apparatus is implemented by a color printer comprised of an image forming section (having four stations a, b, c, and d that are juxtaposed and are identical in construction with one another), a sheet feed section, an intermediate transfer section, a conveying section, a fixing unit, an operating section, and a control unit (not shown).

In the image forming section, photosensitive drums 11a, 11b, 11c, and 11d, as image carriers are rotatively driven in a direction indicated by arrows in FIG. 8. Arranged on outer peripheries of the photosensitive drums in a direction of rotation thereof are roller chargers 12a, 12b, 12c, and 12d, scanners 13a, 13b, 13c, and 13d, and developing devices 14a, 14b, 14c, and 14d for yellow, cyan, magenta, and black, respectively.

The roller chargers 12a to 12d apply a uniform amount of electric charge to surfaces of the photosensitive drums 11a to 11d. Subsequently, the scanners 13a to 13d cause the surfaces of the respective photosensitive drums to be exposed to rays of light modulated according to a recording image signal, so that electrostatic latent images are formed on the surfaces of the photosensitive drums. The developing devices 14a to 14d visualize the electrostatic latent images on the surfaces of the photosensitive drums. The visualized images are transferred onto an intermediate transfer belt 30. By the above processing, images are successively formed using respective toners.

In the sheet feed section, sheet feed (pick-up) rollers 22a, 22b, 22c, and 22d each feed recording materials P one by one from a corresponding one of sheet cassettes 21a, 21b, 21c, and 21d. Each of the recording materials P separated by one of the feed rollers 22a to 22d is conveyed to a pair of registration rollers 25 by a corresponding pair of drawing rollers 24a to 24d and a pair of pre-registration rollers 26. In addition to the above components, the sheet feed section includes a sensor (not shown) for detecting passage of the recording materials P, a sensor (not shown) for detecting presence of the recording materials P, and guides (not shown) for conveying the recording materials P along a conveying path.

In the intermediate transfer section, the intermediate transfer belt 30 is supported by a driven roller 34, is driven by a driving roller 32, and is stretched with a proper tension by a tension roller 33. Primary transfer rollers 35a to 35d for transferring toner images onto the intermediate transfer belt 30 are arranged in facing relation to the respective photosensitive drums 11a to 11d with the intermediate transfer belt 30 interposed therebetween. A secondary transfer roller 36 is disposed in facing relation to the driven roller 34 such that a secondary transfer region is formed by a nip between the secondary transfer roller 36 and the intermediate transfer belt 30. In FIG. 8, reference numeral 50 designates a cleaning device.

The fixing unit 40 is comprised of a fixing roller 41a with an internal heat source such as a halogen heater, a pressurizing roller 41b which is pressurized against the fixing roller 41a, and an internal sheet discharging roller 44 which conveys recording materials P discharged from the roller pair 41a, 41b.

On the other hand, when a recording material P is conveyed to the pair of registration rollers 25, driving of rollers which are upstream of the pair of registration rollers 25 is stopped to temporarily halt the recording material P. Thereafter, driving of the rollers including and upstream of the registration roller pair 25 is restarted according to image formation timing of the image forming section. Thus, the recording material P is fed to the secondary transfer region where the images on the intermediate transfer belt 30 are transferred onto the recording material P. The transferred images are fixed by the fixing unit 40. After the recording material P with images fixed thereon passes through the internal sheet discharging roller 44, the destination of the recording material P is selectively changed by a switching flapper 73 according to which the recording material P is fed to either a face-up sheet discharge tray 2 or a face-down discharge tray 3 through pairs of inversion rollers 72a, 72b, and 72c.

A plurality of sensors are arranged along the conveying path for the recording material P to detect passage of the recording material P, including sheet feed retry sensors 64a to 64d, a deck drawing sensor 66, a registration sensor 67, an internal discharged sheet sensor 68, a face-down discharged sheet sensor 69, a double-sided pre-registration sensor 70, and a double-sided sheet re-feed sensor 71. Cassette sheet detecting sensors 63a to 63d are arranged in respective cassettes 21a to 21d to detect presence/absence of recording materials P thereon.

The control unit includes a control circuit board (not shown) for controlling the operations of mechanisms in the above respective sections and units, a motor driving circuit board (not shown), and others.

A description will now be given of an operation in which recording materials are conveyed from the cassette 21a as an example of operations of the image forming apparatus.

When a predetermined period of time elapses after generation of an image formation start signal, first, the feed roller unit 22a starts to be driven to feed recording materials P one by one from the sheet feed cassette 21a. Each recording material P is conveyed to the registration rollers 25 via the drawing rollers 24a and the pre-registration rollers 26. At this time, the registration rollers 25 are inoperative so that a leading end of the recording material P abuts on a nip formed between the registration rollers 25. Thereafter, the registration rollers 25 start rotating in timing in which image formation is started by the image forming section.

On the other hand, in the image forming section, when an image formation start signal is generated, a toner image formed on the photosensitive drum 11d located most upstream in the rotational direction of the inter mediate transfer belt 30 is primarily transferred onto the intermediate transfer belt 30 by the primary transfer roller 35d with a high voltage applied thereto. The toner image primarily transferred onto the intermediate transfer belt 30 is then conveyed to the next primary transfer region where image formation is similarly carried out so that the next toner image is transferred onto the intermediate transfer belt 30 in a manner superimposed upon the previously formed toner image. Subsequently, the same processing is repeated for the other color components, and finally, a four-color toner image is primarily transferred onto the intermediate transfer belt 30.

When the recording material P enters the secondary transfer region, which is formed between the intermediate transfer belt 30 and the secondary transfer roller 36, to come into contact with the intermediate transfer belt 30, a high voltage is applied to the secondary transfer roller 36 by which the four-color toner image formed on the intermediate transfer belt 30 is transferred onto the surface of the recording material P. Then, the toner image on the recording material P is fixed by the fixing roller pair 41a and 41b, and then the recording material P is selectively discharged to either the face-up sheet discharge tray 2 or to the face-down sheet discharge tray 3.

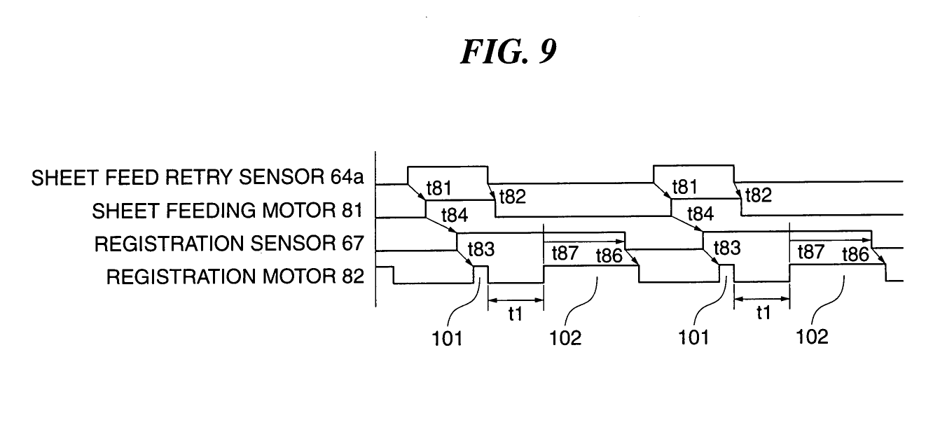

FIG. 9 is a timing diagram showing an example of control of a registration motor of the image forming apparatus.

The control example of FIG. 9 is an application of the present invention to control the registration motor 82 that drives the registration roller pair 25 (FIG. 8), using the position control pattern 101. The control unit 112 (FIG. 1) detects a recording material P in response to an output from the sheet feed retry sensor 64a, and after the lapse of a predetermined period of time t81, activates a sheet feeding motor 81 that drives the drawing roller 24. After activation of the sheet feeding motor 81, the recording material P is conveyed to the location of the registration sensor 67 in a predetermined period of time t84.

The control unit 112 turns on the registration sensor 67 and detects the recording material P from an output from the registration sensor 67 and carries out registration control for synchronization with the timing of the image forming operation. Then, after the lapse of a predetermined period of time t83, the control unit 112 starts to drive the registration motor 82. Upon the lapse of a predetermined period of time t87 after the registration motor 82 starts to be driven, the control unit 112 turns off the registration sensor 67, and then, upon the lapse of a predetermined period of time t86, the control unit 112 stops driving of the registration motor 82. In the present embodiment, upon the lapse of the predetermined period of time t83 after the registration sensor 67 is turned on, driving pulses according to the position control pattern 101 are applied to the registration motor 82 to thereby reduce the noise of the image forming apparatus.

As the period of time t1 after application of driving pulses according to the position control pattern 101 and until driving pulses according to the motor control pattern 102 are applied to the registration motor 82, the control unit 112 sets a minimum period of time required for vibrations generated by the gears driven by the registration motor 82 to converge. That is, as mentioned before, the predetermined period of time t1 is set to a minimum period of time required for the level of vibrations detected by the vibration sensor 114 to become equal to or lower than the threshold value Lth after application of driving pulses according to the position control pattern 101. Further, when setting the period of time t1, the control unit 112 also takes into account a period of time in which the gears cannot be affected by vibrations due to other external factors such as collision of recording materials P. By setting the period of time t1 in this way, it is possible to prevent the gap 123 (see FIG. 3) from being formed again between the gears.

In addition to the registration motor 82 as a driving source of the registration rollers 25, the present invention can also be applied to other driving sources in the image forming apparatus, which drive conveying mechanisms of recording materials P, such as the sheet feed roller unit 22a and the drawing roller 24. In this way, noise due to the gap 123 can be effectively reduced. In particular, the present invention can advantageously be applied to driving sources which are repeatedly or successively turned on and off to assure reducing or removing the gap 123 between gears inevitably created when the driving source is stopped, so that the overall noise of the image forming apparatus can be more effectively reduced.

As described above, according to the present embodiment, the position control is first carried out using the position control pattern 101 to move the driving gear 121 by a predetermined amount to reduce or minimize a gap formed between the driving gear 121 and the transmission gear 122 before the drive control is performed using the motor control pattern 102 to drive the driving gear 121 and the transmission gear 122 in a normal way. As a result, the present embodiment can improve the quietness during operation of a pulse motor without changing or redesigning a motor driving circuit to reduce noise as in the prior art and without causing an increase in load torque due to energization or urging of gears by a spring as in the prior art.

Further, since the output torque of the pulse motor 111 during the position control is set to be less than that of the pulse motor during the driving control, the impact caused by collision of the driving gear 121 and the transmission gear 122 can be reduced, and the gears can be prevented from forming again the gap 123 by such collision and vibrations.

Moreover, since the resolution of the method of excitation of the pulse motor 111 during execution of the position control is set to be higher than that of the method of excitation of the pulse motor 111 during execution of the driving control, the possibility of collision of the driving gear 121 and the transmission gear 122 and the impact of collision can be reduced or minimized.

Further, since a predetermined time interval is provided between the position control and the drive control, vibrations of the gears 121 and 122 can converge before the drive control is started, and the gears can be prevented from forming again the gap therebetween.

Further, since in the drive control that is carried out when a predetermined period of time has passed after execution of the position control, the acceleration of the pulse motor 111 is progressively decreased with time, the noise at the startup of the 5 pulse motor can be reduced.

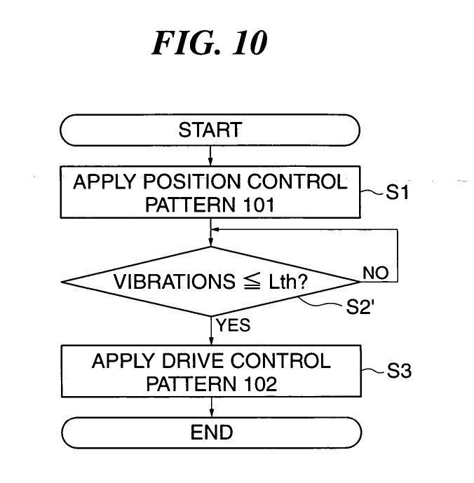

Although in the above embodiment, the drive control is started when the predetermined period of time t1 elapsed after execution of the position control, alternatively, the drive control may be started when the level of vibrations detected by the vibration sensor 114 has become equal to or lower than the threshold value Lth. In this case, the step S2 in FIG. 7 is replaced by a step S2′ in which it is determined whether or not the level of vibrations detected by the vibration sensor 114 has become equal to or lower than the threshold value Lth, as shown in FIG. 10.

Since after the position control, when vibrations detected by the vibration sensor 114 fall below the threshold value, the drive control is started, vibrations caused by the gap at the start of the pulse motor can be surely reduced before the drive control is carried out, and noise can be reliably reduced.

Although in the above embodiment, the patterns 1 to 3 are selectively used as a startup section (time intervals t2 to t4 in FIG. 4) of the motor control pattern to start driving the pulse motor, the present invention is not limited to this, but the number of motor control patterns can be any number within the scope of the present invention.

Although in the above embodiment, the motor drive control apparatus according to the present invention is applied to an image forming apparatus (printer), the present invention is not limited to this, but can also be applied to any other image forming apparatus such as a copy machine and a multifunction apparatus.

It is to be understood that the object of the present invention may also be accomplished by supplying a computer or a CPU with a program code of software (including a program code for implementing the flowchart of FIG. 7) which realizes the functions of the above-described embodiment, and causing a computer (or CPU or MPU) to read out and execute the program code.

It is to be understood that the object of the present invention may also be accomplished by supplying a system or an apparatus with a storage medium in which a program code of software which realizes the functions of the above described embodiment is stored, and causing a computer (or CPU or MPU) of the system or apparatus to read out and execute the program code stored in the storage medium.

In this case, the program code itself read from the storage medium realizes the functions of the embodiment described above, and hence the program code and the storage medium in which the program code is stored constitute the present invention.

Examples of the storage medium for supplying the program code include a floppy (registered trademark) disk, a hard disk, a magnetic-optical disk, an optical disk such as a CD-ROM, a CD-R, a CD-RW, a DVD-ROM, a DVD-RAM, a DVD−RW, and a DVD+RW, a magnetic tape, a nonvolatile memory card, and a ROM. Alternatively, the program may be downloaded via a network.

Further, it is to be understood that the functions of the above described embodiment may be accomplished not only by executing a program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or in an expansion unit connected to the computer and then causing a CPU or the like provided in the expansion board or the expansion unit to perform a part or all of the actual operations based on instructions of the program code.

### CROSS REFERENCE TO RELATED APPLICATION

This application claims priority from Japanese Patent Application No. 2004-290563 filed Oct. 1, 2004, which is hereby incorporated by reference herein.

What is claimed is:

1. A motor drive control apparatus connected to a motor via a driving mechanism including a driving gear disposed on an output side of the motor, and a driven gear engaging the driving gear, comprising:
a drive control section that drives the motor to transmit a driving force of the motor to a load via the driving gear and the driven gear; and
a position control section that performs position control to move the driving gear by a predetermined amount such that a gap formed between the driving gear and the driven gear is reduced or removed, before said drive control section performs drive control to drive the driving gear and the driven gear,
wherein said drive control section performs the drive control when a predetermined period of time has elapsed after the position control is performed by said position control section.

2. A motor drive control apparatus as claimed in claim 1, wherein the predetermined period of time is set to a period of time required for vibrations of the driving gear or the driven gear caused by execution of the position control to converge.

3. A motor drive control apparatus as claimed in claim 1, wherein said position control section sets output torque of the motor during execution of the position control to a value less than that of the motor during execution of the drive control.

4. A motor drive control apparatus as claimed in claim 1, wherein said position control section sets resolution of a method of excitation of the motor during execution of the position control to a value higher than that of a method of excitation of the motor during execution of the drive control.

5. A motor drive control apparatus as claimed in claim 1, wherein said drive control section progressively decreases acceleration of the motor during execution of the drive control with time.

6. A motor drive control apparatus connected to a motor via a driving mechanism including a driving gear disposed on an output side of the motor, and a driven gear engaging the driving gear, comprising:
a drive control section that drives the motor to transmit a driving force of the motor to a load via the driving gear and the driven gear;
a position control section that performs position control to move the driving gear by a predetermined amount such that a gap formed between the driving gear and the driven gear is reduced or removed, before said drive control section performs drive control to drive the driving gear and the driven gear; and
a vibration sensor that detects a level of vibrations generated by driving of the driving gear and the driven gear by the motor,
wherein said drive control section performs the drive control when the level of vibrations detected by said vibration sensor falls below a predetermined value.

7. An image forming apparatus comprising:
an image forming section that forms an image on a recording material;
a first roller that feeds the recording material;
a first motor that drivingly drives said first roller;
a second roller that feeds the recording material fed by said first roller to an image forming position of said image forming portion;
a second motor that rotatively drives said second roller;
a driving gear disposed on an output side of said second motor;
a driven gear engaging said driving gear;
a sensor that detects the recording material upstream of said second roller;
a drive control section that drives said second motor to transmit a driving force of said second motor to a load via said driving gear and said driven gear; and
a position control section that performs position control to move said driving gear by a predetermined amount such that a gap formed between said driving gear and said driven gear is reduced or removed, before said drive control section performs drive control to drive said driving gear and said driven gear,
wherein said position control section performs the position control of said second motor when a predetermined period of time has elapsed after detection of the recording material by said sensor.

8. A control method for controlling a driving mechanism that drives a motor to transmit a driving force of the motor to a load via a driving gear disposed on an output side of the motor and a driven gear engaging the driving gear, comprising:
a position control step of performing position control to move the driving gear by a predetermined amount such that a gap formed between the driving gear and the driven gear is reduced or removed; and
a drive control step of performing drive control of the motor to drive the load when a predetermined period of time has elapsed after the position control is performed in said position control step.

9. A control method for controlling a driving mechanism that drives a motor to transmit a driving force of the motor to a load via a driving gear disposed on an output side of the motor and a driven gear engaging the driving gear, comprising:
a position control step of performing position control to move the driving gear by a predetermined amount such that a gap formed between the driving gear and the driven gear is reduced or removed;
a detecting step of detecting a level of vibrations generated by driving of the driving gear and the driven gear by the motor; and
a drive control step of performing drive control of the motor to drive the load when the level of vibrations detected in said detecting step falls below a predetermined value after said position control step.
